(19) United States
(12) Patent Application Publication
(10) Pub. No.: US 2008/0215350 A1
(43) Pub. Date: Sep. 4, 2008

(54) DOCUMENT PROCESSING APPARATUS, DOCUMENT PROCESSING METHOD, COMPUTER READABLE MEDIUM AND COMPUTER DATA SIGNAL

(75) Inventors: Kenji NISHIYAMA, Kawasaki-shi (JP); Shinji KAWABATA, Kawasaki-shi (JP); Nobuo SUZUKI, Kawasaki-shi (JP)

Correspondence Address: SUGHRUE-265550, 2100 PENNSYLVANIA AVE. NW, WASHINGTON, DC, 20037-3213, US

(73) Assignee: FUJI XEROX CO., LTD., Tokyo (JP)

(21) Appl. No.: 11/843,392

(22) Filed: Aug. 22, 2007

(30) Foreign Application Priority Data
Aug. 22, 2006 (JP) 2006-225390

(51) Int. Cl. G06Q 10/00

(52) U.S. Cl. 705/1

(57) ABSTRACT

A document processing apparatus includes an activity input unit and a document creation unit. The activity input unit allows a user to input activities each including a name of the activity and a task description. The document creation unit creates, based on the activities input through the activity input unit, a document for an inner control including at least one of a business process narrative describing a flow of each business process, a business flow diagram visually describing the flow of each business process, a risk control matrix indicating assumed risks and control activities corresponding to the respective risk and a separation-of-duties table showing a correspondence relation between a person in charge and each business process.

### BACKGROUND

1. Technical Field

The invention relates to a document processing apparatus, a document processing method, a computer readable medium storing a document processing program and a computer data signal embedded with the document processing program.

2. Description of the Related Art

In recent years, a financial inner control has been requested. As to the financial inner control, “inner control-integrated framework” announced by COSO (Treadway committee organizing committee) in 1992 has become a de facto standard and is defined as “a process that is executed by a board of directors, executives and other personnels and that is intended to provide a rational guarantee in order to achieve three objects of (1) effectiveness/efficiency of task, (2) reliability of financial statements, (3) compliance to related laws and regulations.”

In the financial inner control, enormous labor has been taken to manually operate and manage (i) organizing of a relationship among activity/system/resource/knowledge information and the like and (i) construction of a mechanism for documenting a business process to make full use of the documents. As documents of the financial inner control, there are four documents, that is, a business process narrative, a business flow diagram, RCM (risk control matrix), a separation-of-duties table.

An operation of documenting the financial inner control is carried out by units of several tens persons. Even when the respective persons are going to individually write the four documents, it is a difficult operation to write the four documents without omission, making levels (granularity) uniform and without discrepancy thereamong.

In two documents of the business process narrative (document of a text in sentence type) and the flowchart (business flow diagram) for expressing a business process, although the same person intends to write the same process in the business process narrative and the flowchart, sometimes the business process narrative and the flowchart do not correspond to each other in descriptions of individual elements, and omission and differences in levels are brought about.

When a document having dispersion in a quality has been formed as described above, discovery of a risk in a pertinent task is oversighted, and dispersion in test items is brought about at a test phase which is a next step in the financial inner control. As a result, look-back operation by manual labor is required for adjusting the variation.

Not only a relationship between the business process narrative and flowchart but also contents described in documents which are necessary to be formed for promoting the inner control, such as RCM and the separation-of-duties table individually correlate. For example, when respectively correlated portions are corrected, labor is taken for correcting other document at each time. As a result, the correction cannot substantially be carried out and the discrepancy among the documents is brought about.

Further, when an operation of editing the business process is continuously executed, transition of states (editing/acknowledged/abandoned or the like) at that occasion is brought about in management of the document in a documenting process (documenting operation). However, it has not been able to collectively control restriction on access to respective documents in accordance with the states.

### SUMMARY

According to an aspect of the invention, A document processing apparatus includes an activity input unit and a document creation unit. The activity input unit allows a user to input activities each including a name of the activity and a task description. The document creation unit creates, based on the activities input through the activity input unit, a document for an inner control including at least one of a business process narrative describing a flow of each business process, a business flow diagram visually describing the flow of each business process, a risk control matrix indicating assumed risks and control activities corresponding to the respective risk and a separation-of-duties table showing a correspondence relation between a person in charge and each business process.

### BRIEF DESCRIPTION OF THE DRAWINGS

Exemplary embodiments of the invention will be described in detail below with reference to the following drawings, wherein:

FIG. 1 is a block diagram showing a configuration example of modules according to an exemplary embodiment;

FIG. 2 is a block diagram showing a configuration example of the entire system;

FIG. 3 is an explanatory view for an example of a relation among tables dealt with in the exemplary embodiment;

FIG. 4 is an explanatory view of an example of a relation among input screens displayed in the exemplary embodiment;

FIG. 5 is an explanatory view of an example of an input screen for a business process narrative;

FIG. 6 is an explanatory view of an example of an input screen for an activity description;

FIG. 7 is an explanatory view of an example of an input screen for a resource attribute;

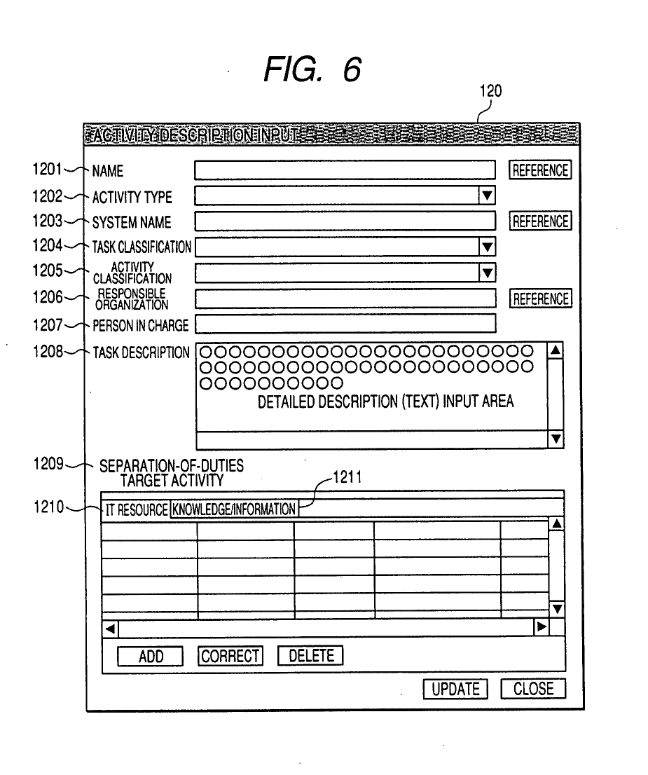

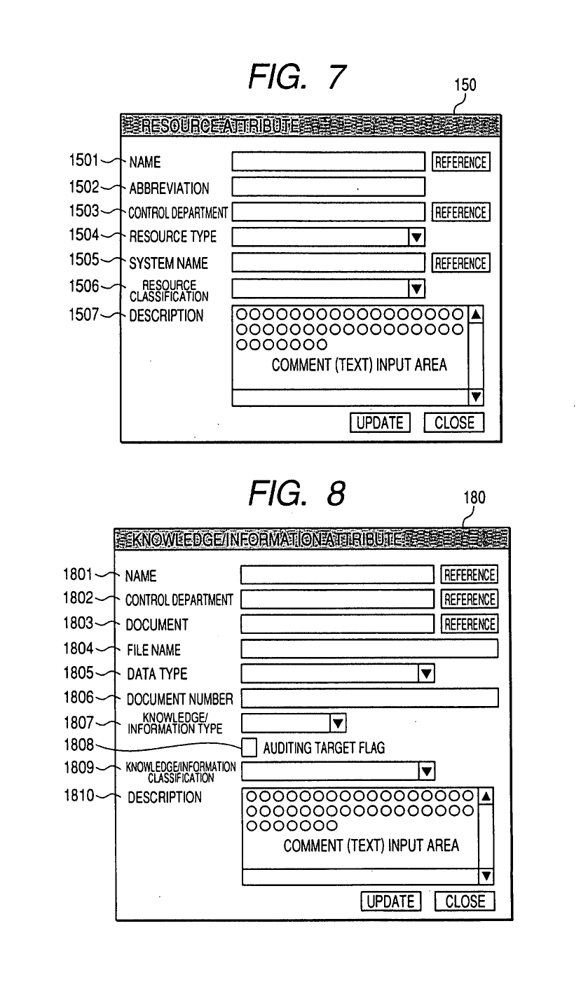

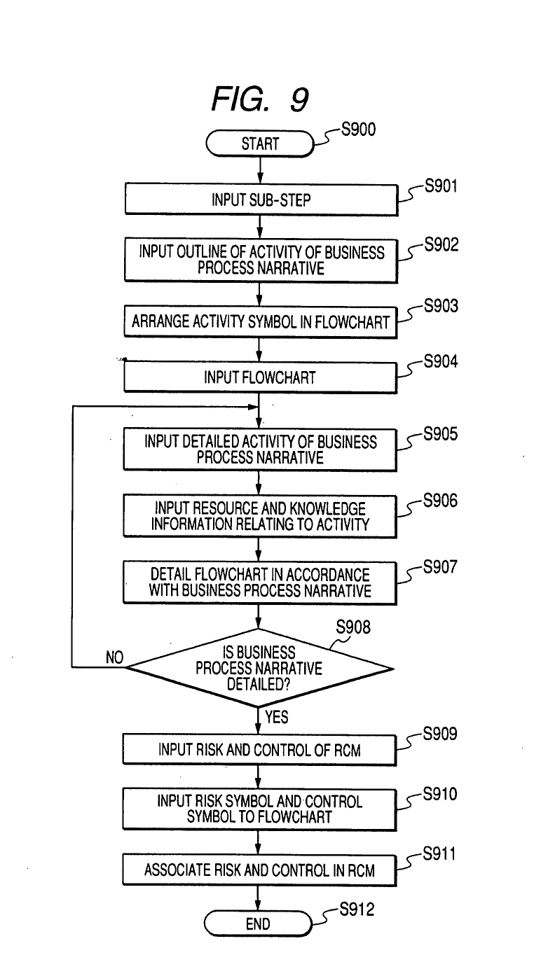

FIG. 6 is an explanatory view of an example of an input screen for a knowledge/information attribute;

FIG. 9 is a flowchart of a process for creating a document for an inner control; and

FIG. 10 is a block diagram showing an example of a hardware configuration of a computer for implementing the exemplary embodiment.

### DETAILED DESCRIPTION

First, an explanation will be given of “basic four documents” of an inner control that is dealt with by the exemplary embodiment.

The basic four documents means basic documents formed for respective business processes which are targets of the financial inner control. Specifically, the basic four documents are a business process narrative, a business flow diagram, RCM (risk control matrix), a separation-of-duties table.

The business process narrative is also referred to as a “narrative.” The business process narrative is one into which documented is a flow of a series of tasks from start of dealings to final entry into the general ledger and report. Regulation documents such as personnel regulations and accounting task regulations are documents at a higher order of the task document, and revision thereof has an influence on the business process narrative. Further, a task manual is a document which is a lower order of the business process narrative and receives the influence on the revision.

The business flow diagram is one obtained by visually forming a flow of the series of tasks from start of dealings to final entry into the general ledger and report, into a flowchart. Also risks and controls are arranged on this flow.

RCM (risk control matrix) is one in which essential points (assertion) in view of controls to be achieved, assumed risks, corresponding inner control activities are summarized as a table with regard to the inner control activities related to a business process.

The separation-of-duties table is one used to check as to whether processes dealt with by the same person in charge overlap each other, which become an issue in view of a financial control in the flow of the business process.

Further, assertion is a premise condition based on which it can be said that financial information is reliable information. Specifically, six items of existence, comprehensiveness, evaluation, right-and-obligation, term/distribution and display are generally used as the “assertion.” These items are partially changed by respective corporations or auditing corporations. Therefore, the items may be customized.

Risk means an impediment to assertion assumed in a business process.

Control means an inner control activity against risk. As a type of the control, there are preventive, discovering and the like.

Exemplary embodiments of the invention will be explained with reference to the drawings below.

In the financial inner control, a business process is documented by organizing a relationship among activity/system/resource/knowledge information and the like and a system for making full use of the document is constructed. Although the system is constructed in units of corporation, one system may be utilized among affiliated corporations (including subsidiary, parent company and the like).

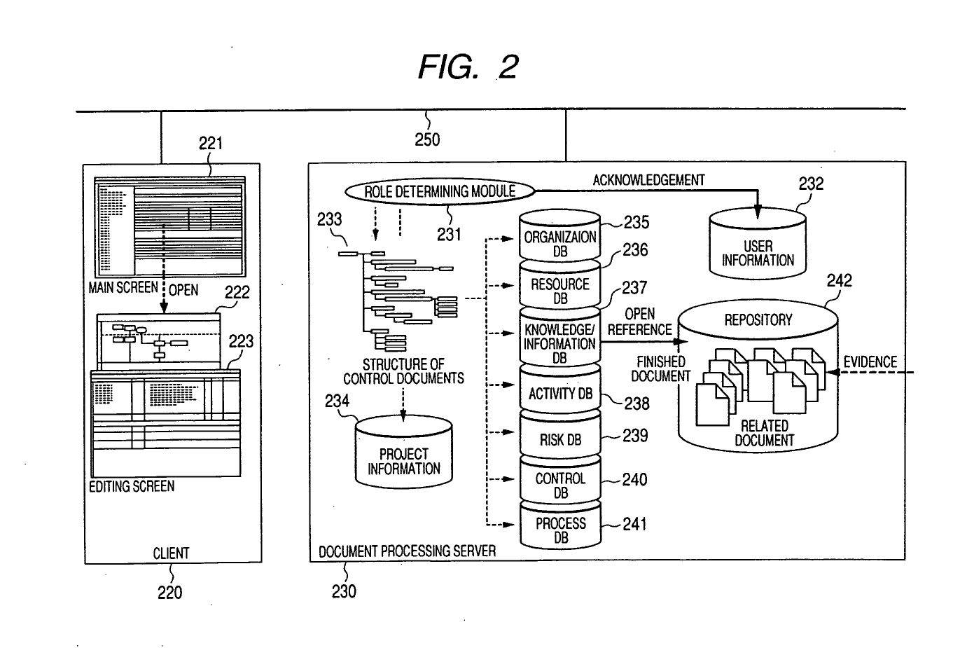

An explanation will be given of a configuration example of the entire system for the financial inner control for implementing the exemplary embodiment, with reference to FIG. 2.

The entire system includes a client 220 and a document processing server 230. Further, each of the client 220 and the document processing server 230 may be plural ones. The client 220 and the document processing server 230 are connected by way of a communication network 250. Further, the client 220 and the document processing server 230 are connected by using a communicating protocol such as HTTP (Hyper Text Transfer Protocol), and data communicated therebetween is described in XML (eXtensible Markup Language) or the like.

The client 220 has a function of user interface that allows an operator to use a main screen 221, an editing screen 222 and an editing screen 223. For example, respective operators in a parent company A and a subsidiary B operate the respective clients 220.

In order to create a document for the financial inner control, the client 220 displays the main screen 221 and displays the editing screen 222 to create the document. In the editing screen 222, the four kinds of control documents (a flowchart regarding a business process, an explanatory sentence, risk control matrix, a separation-of-duties table) are created. Also, the editing screen 22 is used to reference the created documents.

The document processing server 230 includes a role determining module 231. The role determining module 231 determines as to whether an operator is a person having a proper role (authorization) for an access from the client 220, by using user information 232.

When the operator is a person having a proper role, the access to a control document or the like is approved for the client 220. A structure of the control document displayed on the editing screen 223 is constituted by a tree structure. That is, the task includes plural tasks, which constitute a layer structure. The control document is formed so as to correspond to the task. Therefore, a structure of the control document is constituted by the tree structure. Further, one task is associated with four kinds of control documents. Further, the plural control documents are stored in project information 234.

Further, the control document is created by using common parts. Here, in the common parts, there are activity, resource, knowledge/information and the like, which are open and can be utilized by a person in charge of creating the document. Organization which is of the common parts is stored in an organization DB235. Resource which is of the common parts is stored in a resource DB236. Knowledge/information which is of the common parts is stored in a knowledge/information DB237. Activity which is of the common parts is stored in an activity DB238. Risk which is of the common parts is stored in a risk DB239. Control which is of the common parts is stored in a control DB234. A process which is of the common parts is stored in a process DB241. Further, the activity means an activity related to a task action executed by a person on the process. The resource means a resource related to a system process, system data and IT. The knowledge/information means a group of documents related to the process. For example, the documents may be regulations, manuals or the like.

In the organization DB235, stored is information of a corporation of which the control document is created (corporation name, address or the like), organization information, user information, accounting items and the like.

Further, the organization DB235 references related documents and finished documents in a repository 242. Conversely, documents to be open in the organization DB235 are stored in the repository 242. Further, there are documents stored in the repository 242 which are used as auditing evidences (auditing sheets or the like). The auditing evidence is for an auditor (inner auditor or outer auditor) to track to survey an arbitrary matter in accordance with an auditing policy.

Further, although the document processing server 230 may be realized by one server, the document processing server 230 may be realized by plural servers. For example, the user information 232, the repository 242 may be realized as a server for another document database.

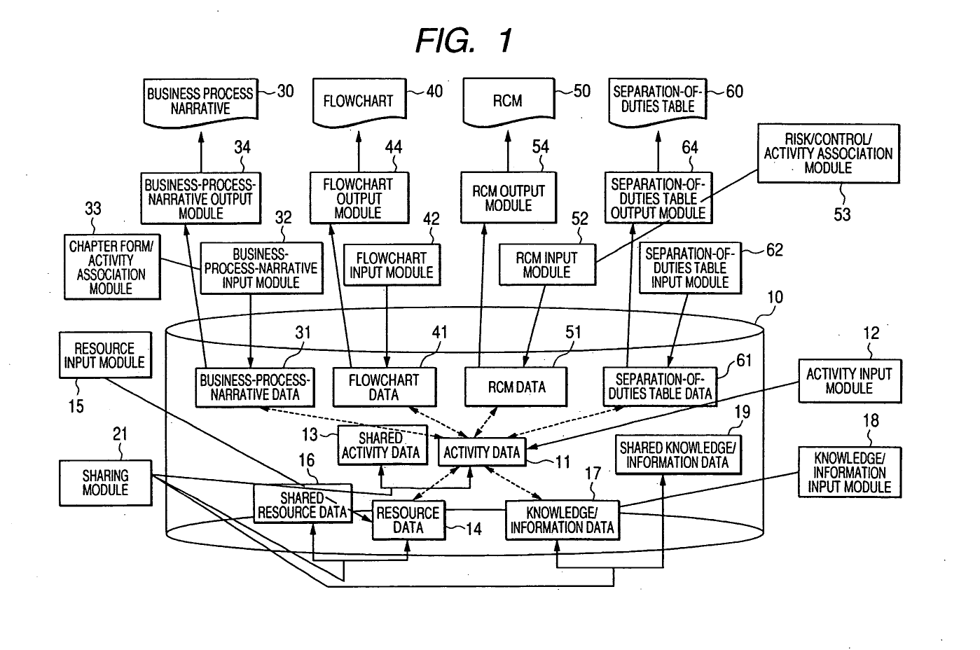

An explanation will be given of an example of a conceptual module configuration according to the exemplary embodiment with reference to FIG. 1.

It is noted that the “module” indicates a part of a software, a hardware or the like which can generally be separated logically. Therefore, the module according to the exemplary embodiment indicates not only a module in a program but also a module in a hardware configuration. Therefore, the exemplary embodiment serves to explain also a program, apparatus, system and method. Further, although the module corresponds to the function substantially in one-two-one relationship, in mounting, one module may be constituted by one program, a plurality of modules may be constituted by one program, conversely, one module may be constituted by a plurality of programs. Further, the plurality of modules may be executed by one computer, or one module may be executed by a plurality of computers in a dispersed or parallel environment. Further, in the following, “connection” includes a physical connection as well as a logical connection. For example, connection of a data and a data signifies that portions of the data are constituted by the same data, and in a pointer or a link or the like, one thereof indicates other thereof.

Further, the system includes a case in which a plurality of computers, hardwares, apparatus or the like are constituted by being connected by a network or the like and a case in which the system is realized by one computer, hardware, apparatus or the like.

As shown in FIG. 1, in a business-process constituting element DB 10, stored are activity data 11, shared activity data 13, resource data 14, shared resource data 16, knowledge/information data 17, shared knowledge/information data 19, business-process-narrative data 31, flowchart data 41, RCM data 51, separation-of-duties table data 61, which may be controlled by separated databases or may be controlled by one database.

The activity data 11 is connected to the business-process-narrative data 31, the flowchart data 41, the RCM data 51, the separation-of-duties table data 61, the resource data 14, the knowledge/information data 17, the shared activity data 13 and activity input module 12. The activity input module 12 is connected to the activity data 11. The shared activity data 13 is connected to the activity data 11. The resource data 14 is connected to the shared resource data 16, the activity data 11 and the resource input module 15. The resource input module 15 is connected to the resource data 14. The shared resource data 16 is connected to the resource data 14. The knowledge/information data 17 is connected to the shared knowledge/information data 19, the activity data 11, and a knowledge/input module 18. The shared knowledge/information data 19 is connected to the knowledge/information data 17. The business-process-narrative data 31 is connected to the activity data 11, a business-process-narrative input module 32, a business-process-narrative output module 34. The flowchart data 41 is connected to the activity data 11, a flowchart input module 42 and a flowchart output module 44. The RCM data 51 is connected to the activity data 11, an RCM input module 52 and an RCM output module 54. The separation-of-duties table data 61 is connected to the activity data 11, a separation-of-duties input module 62 and a separation-of-duties table output module 64.

Further, a sharing module 21 connects the activity data 11 and the shared activity data 13, and renders data in the activity data 11 to be shared so that other persons in charge can use the data. By sharing, data of the shared activity data 13 is open to other operators (persons in charge). Similarly, the sharing module 21 connects the resource data 14 and the shared resource data 16 and connects the knowledge/information data 17 and the shared knowledge/information data 19. The sharing module 21 renders data in the resource data 14 and data in the knowledge/information data 17 to be shared so that other persons in charge can use those data. By sharing, data in the shared resource data 16 and data in the shared knowledge/information data 19 are open also to other operators (persons in charge). That is, the authorizations for access to the data in the shared activity data 13, the data in the shared resource data 16, the data in the shared knowledge/information data 19 are set so as to enable other operators to browse and copy. However, only the operator of the sharing module 21 can write into the shared activity data 13, the shared resource data 16 and the shared knowledge/information data 19.

As a module for inputting data to the business-process constituent element DB 10, there is the business-process-narrative input module 32, the flowchart input module 42, the RCM input module 52 and the separation-of-duties table input module 62. The business-process-narrative input module 32 is connected to the business-process-narrative data 31 and chapter format/activity association module 33. The flowchart input module 42 is connected to the flowchart data 41. The RCM input module 52 is connected to the RCM data 51 and a risk/control/activity association module 53. The separation-of-duties table input module 62 is connected to the separation-of-duties table data 61. The chapter format/activity association module 33 is connected to the business-process-narrative input module 32. The risk/control/activity association module 53 is connected to the RCM input module 52.

As modules for outputting data from the business-process constituent element DB 10, there are the business-process-narrative output module 34, the flowchart output module 44, the RCM output module 54 and the separation-of-duties table output module 64. The business-process-narrative output module 34 is connected to the business-process-narrative data 31, and outputs a business process narrative 30. The flowchart output module 44 is connected to the flowchart data 41 and outputs a flowchart 40. The RCM output module 54 is connected to the RCM data 51 and outputs an RCM 50. The separation-of-duties table output module 64 is connected to the separation-of-duties table data 61 and outputs a separation-of-duties table 60.

The activity data 11 constitutes original data in creating the basic four documents for the inner control (the business process narrative 30, the flowchart 40, the RCM 50, the separation-of-duties table 60). That is, the activity input module 12 receives information regarding an activity including a name of the activity and a task description by input operation of the operator (person who creates a document) and stores the received information regarding the activity in the activity data 11.

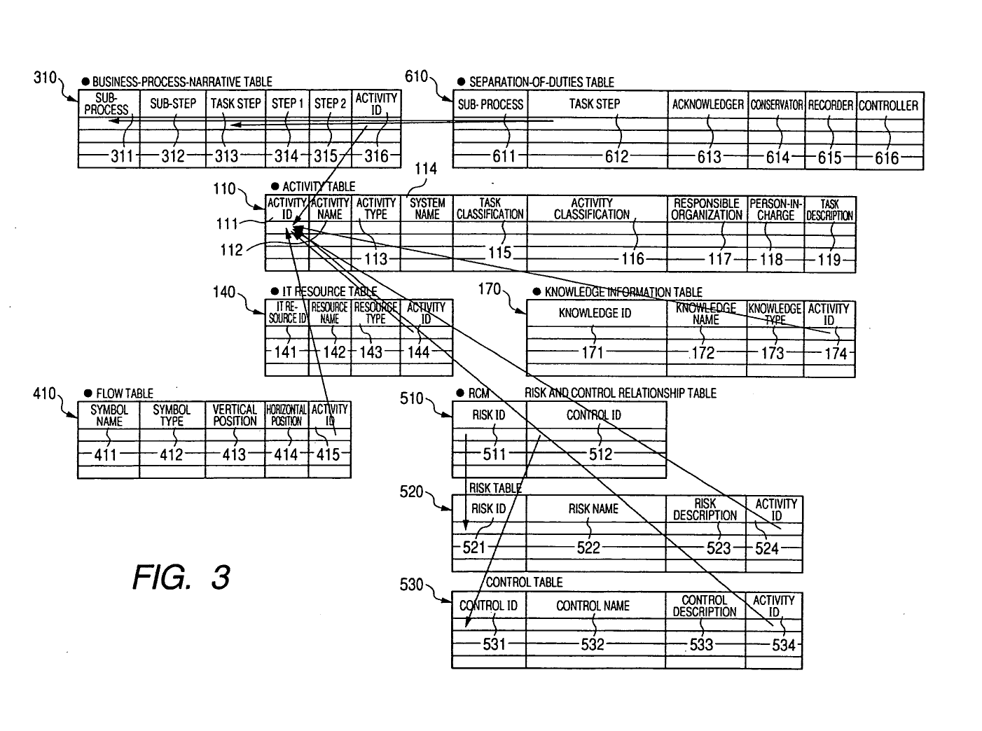

A detailed explanation will be given of an example of a relationship among data in the business-process constituent element DB 10 with reference to FIG. 3.

FIG. 3 shows a relationship among an activity table 110, an IT resource table 140, a knowledge information table 170, a business-process-narrative table 310, a separation-of-duties table 610, a flow table 410, an RCM 510, a risk table 520, a control table 530. It is noted that columns of the respective tables indicate mere examples and columns may be added thereto to store other information.

The activity table 110 corresponds to the activity data 11 of FIG. 1. The activity data 110 includes an activity ID column 111, an activity name column 112, an activity type column 113, a system name column 114, a task classification column 115, an activity classification column 116, a responsible organization column 117, a person-in-charge column and a task description column 119. The activity ID stored in the activity ID column 111 is an identifier that uniquely identifies an activity input by the operator. Further, the activity ID is used in an activity ID column 316 of the business-process-narrative table 310, an activity ID column 144 of the ID resource table 140, an activity ID column 174 of the knowledge information table 170, an activity ID column 415 of the flow table 410, an activity ID column 524 of the risk table 520 and an activity ID column 534 of the control table 530. The respective tables are associated with the activity table 110.

Therefore, a corresponding activity can be searched for from the respective tables. For example, when an activity included in a certain sub-process in the business process narrative is search for, the activity ID column 111 of the activity table 110 is searched based on an activity ID which is stored in the activity ID column 316 and which corresponds to the sub-process at issue. Thereby, it becomes possible to search for an activity name, a task description and the like corresponding to the pertinent activity ID. Further, conversely, items of the respective tables can be searched for from the activity ID. For example, when a risk corresponding to a certain activity ID is searched for, the activity ID is searched for from the activity ID column 524 of the risk table 520, and a risk name, a risk description and the like are searched for based on the corresponding activity ID. Information stored in from the activity name column 112 to the task description column 119 will be described later with reference to FIG. 6.

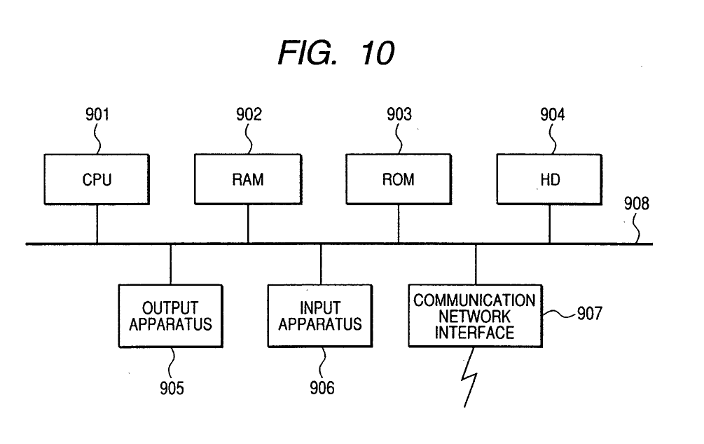

The IT resource table 140 corresponds to the resource data 14 of FIG. 1. The IT resource table 140 includes an IT resource ID column 141, a resource name column 142, a resource type column 143 and the activity ID column 144. An activity ID stored in the activity ID column 144 is similar to the activity ID stored in the activity ID column 111 of the activity table 110. The activity ID stored in the activity ID column 144 associates the IT resource table 140 with the activity table 110. Information stored in from the IT resource ID column 141 to the resource type column 143 will be described later with reference to FIG. 7.

The knowledge information table 170 corresponds to the knowledge/information data 17 of FIG. 1. The knowledge information table 170 includes a knowledge ID column 171, a knowledge name column 172, a knowledge type column 173 and the activity ID column 174. An activity ID stored in the activity ID column 174 is similar to the activity ID stored in the activity ID column 111 of the activity table 110. The activity ID stored in the activity ID column 174 associates the knowledge information table 170 with the activity table 110. Information stored in from the knowledge ID column 171 to the knowledge type column 173 will be described later with reference to FIG. 8.

The business-process-narrative table 310 corresponds to the business-process-narrative data 31 of FIG. 1. The business process narrative is created based on the business-process-narrative table 310. The business-process-narrative table 310 includes a sub-process column 311, a sub-step column 312, a task step column 313, a step-1 column 314, a step-2 column 315 and the activity ID column 316. An activity ID stored in the activity ID column 316 is similar to the activity ID stored in the activity ID column 111 of the activity table 110. The activity ID stored in the activity ID column 316 associates the business-process-narrative table 310 with the activity table 110.

A hierarchy expressing the business process in the business process narrative is broken into five levels. That is, level matching is carried out by standardizing the break-down levels to the five levels. The sub-process, the sub-step or the like is arbitrarily set by a person who creates the business process narrative. By setting the five levels, even if there are plural persons who create the business process narrative, a granularity thereof (a size when summarized to one sub-process) becomes constant.

The sub-process stored in the sub-process column 311 is at the highest level of the five levels.

The sub-step stored in the sub-step column 312 is at a lower level than the sub-process.

A task step stored in the task step column 313 is at a lower level than the sub-step.

A step 1 stored in the step-1 column 314 is at a lower level than the task step.

A step 2 stored in the step-2 column 315 is at a lower level than the step 1, and is at the lowest level of the five levels. There may be a case where the step-2 column 315 includes plural activity IDs.

The separation-of-duties table 610 corresponds to the separation-of-duties table data 61 of FIG. 1. The separation-of-duties table is created based on the separation-of-duties table 610. The separation-of-duties table 610 includes a sub-process column 611, a task step column 612, an acknowledge column 613, a conservator column 614, a recorder column 615, a controller column 616. A sub-process stored in the sub-process column 611 is similar to the sub-process stored in the sub-process column 311 of the business-process-narrative table 310. The sub-process stored in the sub-process column 611 associates the separation-of-duties table 610 with the business process narrative 310. Similarly, a task step stored in the task step column 612 is similar to the task step stored in the task step column 313 of the business-process-narrative table 310. The task step stored in the task step column 612 associates the separation-of-duties table 610 with the business-process-narrative table 310. That is, the sub-process and the business process step in the separation-of-duties table are constituted by developing the sub-process and the task step in the business process narrative, and there is no discrepancy therebetween.

Also, names or identifiers of respective persons in charge of conservation, recording and control are stored in from the acknowledge column 613 to the controller column 616.

The flow table 410 corresponds to the flow data 41 of FIG. 1. The flowchart (business flow diagram) is created based on the flow table 410. The flow table 410 includes a symbol column name 411, a symbol type column 412, a vertical position column 413, a horizontal position column 414 and the activity ID column 415. An activity ID stored in the activity ID column 415 is similar to the activity ID stored in the activity ID column 111 of the activity table 110. The activity ID stored in the activity ID column 415 associates the flow table 410 with the activity table 110.

A symbol name stored in the symbol name column 411 is a name of a symbol used in the flowchart.

A symbol type stored in the symbol type column 412 is a type expressed by a symbol (for example, determination, process, input, output or the like).

A vertical position stored in the vertical position column 413 and a horizontal position stored in the horizontal position column 414 specify a position of the symbol in the flowchart.

The RCM 510, the risk table 520, the control table 530 corresponds to the RCM data 51 of FIG. 1. The RCM is created based on RCM 510, the risk table 520 and the control table 530. The RCM 510 includes a risk ID column 511 and a control ID column 512. The risk table 510 includes a risk ID column 521, a risk name column 522, a risk description column 523 and the activity ID column 524. The control table 530 includes a control ID column 531, a control name column 532, a control description column 533 and the activity ID column 534.

An activity ID stored in the activity ID column 524 of the risk table 520 is similar to the activity ID stored in the activity ID column 111 of the activity table 110. The activity ID stored in the activity ID column 524 associates the risk table 520 with the activity table 110. An activity ID stored in the activity ID column 534 of the control table 530 is similar to the activity ID stored in the activity ID column 111 of the activity table 110. The activity ID stored in the activity ID column 534 of the control table 530 associates the control table 530 with the activity table 110.

A risk ID stored in the risk ID column 511 of the RCM 510 is an identifier for uniquely identifying a risk. The control ID stored in the control ID column 512 of the RCM 510 is an identifier for uniquely identifying a control.

Also, a risk ID stored in the risk ID column 521 of the risk table 520 is similar to the risk ID stored in the risk ID column 511 of RCM 510. The risk ID stored in the risk ID column 521 of the risk table 520 associates the risk table 520 with the RCM 510. Similarly, a control ID stored in the control ID column 531 of the control table 530 is similar to the control ID stored in the control ID column 512 of RCM 510. The control ID stored in the control ID column 531 of the control table 530 associates the control table 530 with the RCM 510.

A risk name stored in the risk name column 522 is a name attached to the risk. A risk description stored in the risk description column 523 explains a content of the risk.

A control name stored in the control name column 532 is a name attached to the control.

A control description stored in the control description column 533 explains a content of the control.

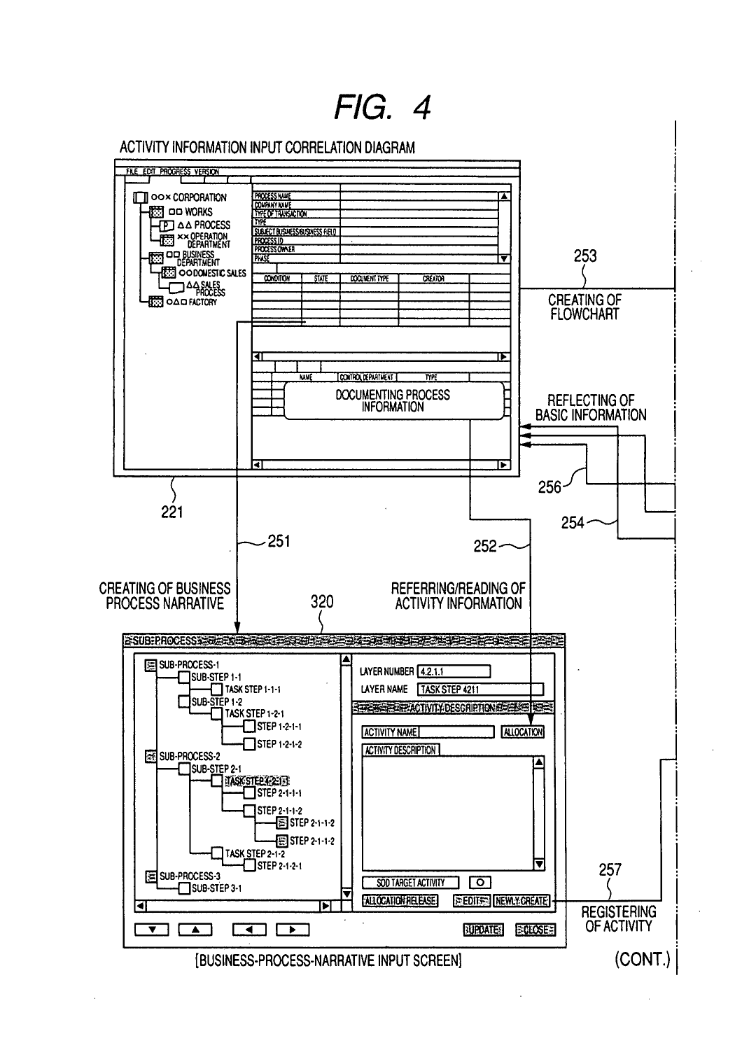

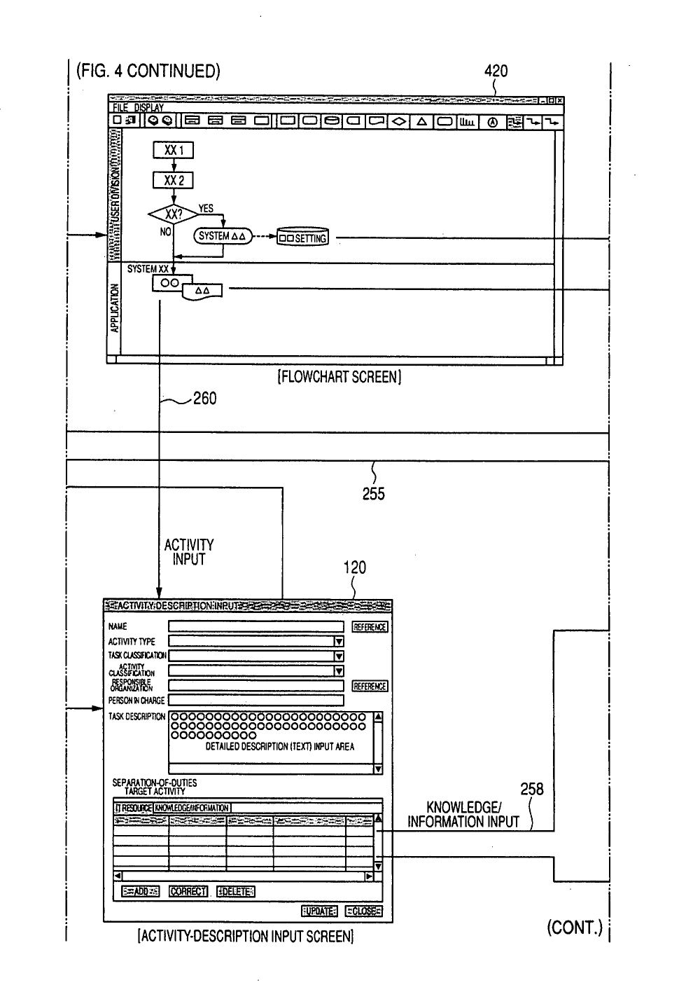

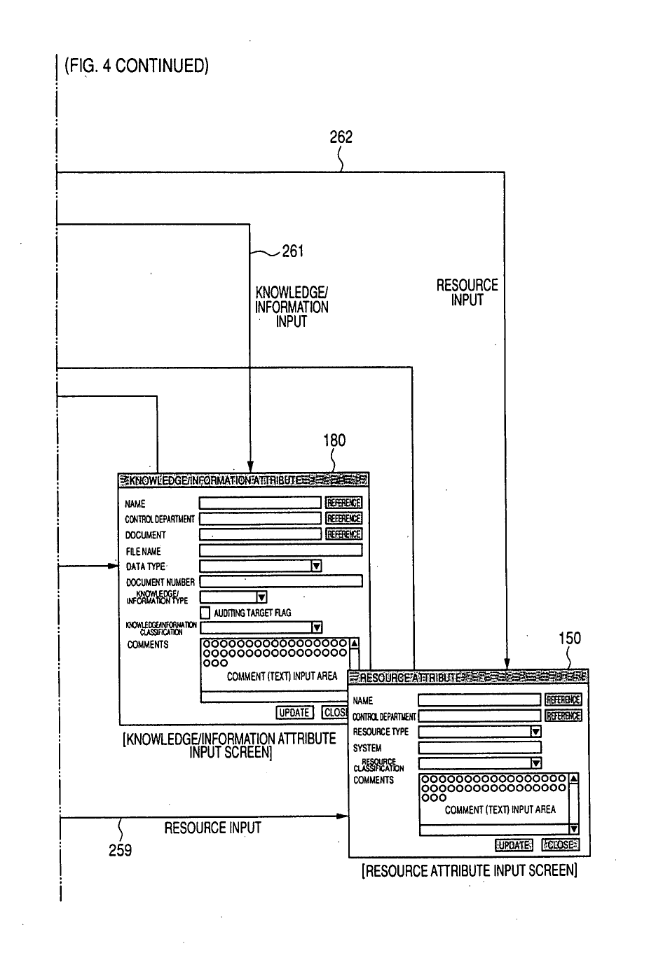

An example of a relation between displayed input screens will be described with reference to FIG. 4.

FIG. 4 shows a relationship among the main screen 221, a business-process-narrative input screen 320, an activity-description input screen 120, a knowledge/information attribute input screen 180, a resource attribute input screen 150 and a flowchart screen 420. Input screens for risk and control in the RCM are displayed in association with symbols in the flowchart screen 420. An input screen for a person in charge in the separation-of-duties table is displayed in association with the business-process-narrative input screen 320. The screens are displayed on a display apparatus of the client 220.

When an operator's operation in the main screen 221 designates creating of a business process narrative 251 or referring/reading of activity information 252, the business-process-narrative input screen 320 is displayed. When the operator's operation designates creating of a flowchart 253, the flowchart screen 420 is displayed.

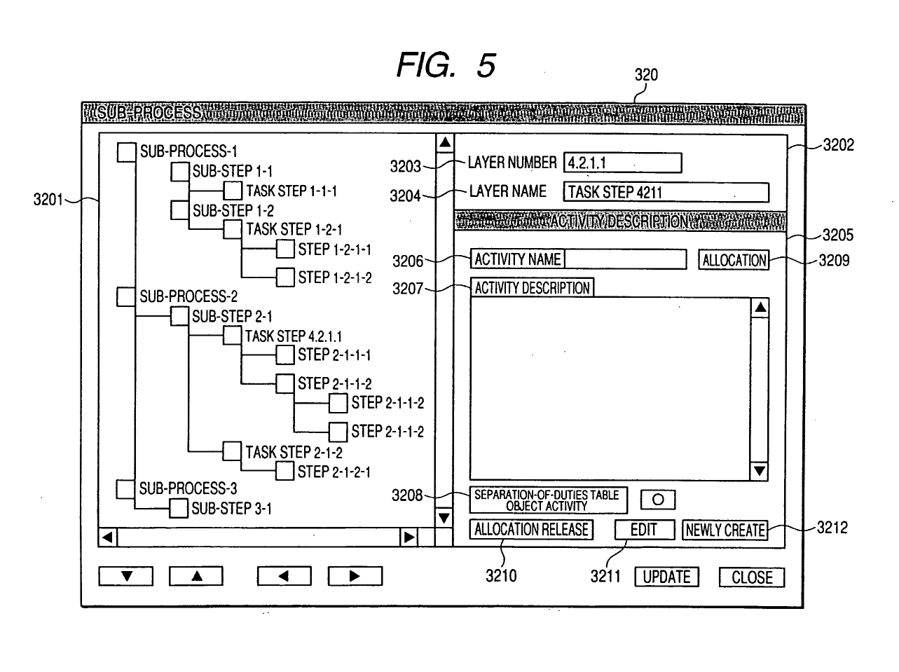

When the operator's operation in the business-process-narrative input screen 320 designates activity registration 257, the activity-description input screen 120 is displayed. The business-process-narrative input screen 320 will be described in details with reference to FIG. 5.

When the operator's operation in the flowchart screen 420 designates activity input 260, the activity-description input screen 120 is displayed. When the operator's operation designates knowledge/information input 261, the knowledge/information attribute input screen 180 is displayed. When the operator's operation designates resource input 262, the resource attribute input screen 150 is displayed.

When the operator's operation in the activity-description input screen 120 designates reflecting of basic information 254, the main screen 221 is displayed. When the operator's operation designates knowledge/information input 258, the knowledge/information attribute input screen 180 is displayed. When the operator's operation designates resource input 259, the resource attribute input screen 250 is displayed. The activity-description input screen 120 will be described in details with reference to FIG. 6.

When the operator's operation the knowledge/information attribute input screen 180 designates reflecting of basic information 255, the main screen 221 is displayed. The knowledge/information attribute input screen 180 will be described in details with reference to FIG. 8.

When the operator's operation in the resource attribute input screen 150 designates reflecting of basic information 256, the main screen 221 is displayed. The resource attribute input screen 150 will be described in details with reference to FIG. 7.

Contents of the business-process-narrative input screen 320 will be described with reference to FIG. 5. The business-process-narrative input module 32 displays the business-process-narrative input screen 320 by using the business-process-narrative data 31 (business-process-narrative table 310). Also, the business-process-narrative input module 32 inputs, to the business-process-narrative data 31 (business-process-narrative table 310), what is input into the business-process-narrative input screen 320 by the operator's operation.

The business-process-narrative input screen 320 is mainly used to create the business process narrative. The business-process-narrative input screen 320 creates a hierarchy (hierarchical set), inputs names of respective layers and associates activities, in accordance with the operator's operation.

A left side of the business-process-narrative input screen 320 displays a process hierarchical level column 3201, and a right side thereof displays a layer column 3202 and an activity description column 3205.

In the process hierarchical level column 3201, a layer relation of the business process narrative is displayed. The layers are unified to the five levels in a similar manner to the tasks. When one layer is selected, description corresponding to the selected layer is displayed in the layer column 3202 and the activity description column 3205 on the right side. FIG. 5 shows a state where “task step 4. 2. 1. 1” is selected.

In the layer column 3202, a layer-number item 3203 and a layer-name item 3204 are displayed so as to prompt the operator to input. In the layer-number item 3203, displayed is numeral which hierarchically indicates a layer number of the layer selected in the process hierarchical level column 3201. In the layer-name item 3204, displayed is a name of the layer corresponding to the layer-number item 3203.

In the activity description column 3205, displayed is an activity name item 3206, an activity description item 3207, a separation-of-duties table target activity item 3208, an allocating button 3209, an allocation releasing button 3210, a content editing button 3211 and a new creation button 3212, so as to prompt the operator to input. When the separation-of-duties target activity item 3208 is selected by the operator, association with the separation-of-duties table is carried out.

When the allocating button 3209 is selected, activities corresponding to a task designated in the process hierarchical level column 3201 are displayed as a list. That is, corresponding activity IDs of the activity table 110 are searched for from the activity ID column 316 of the business-process-narrative table 310, and a list of the found activity name is displayed.

When the allocation releasing button 3210 is selected, association for an activity currently designated (associated) is released.

When the content editing button 3211 is selected, the corresponding activity-description input screen 120 is displayed so that contents of the activity currently designated (associated) can be edited. That is, the activity input module 12 is activated.

When the new creation button 3212 is selected, a new activity-description input screen 120 is displayed. That is, the activity input module 12 is activated.

Contents of the activity-description input screen 120 will be described with reference to FIG. 6. The activity input module 12 displays the activity-description input screen 120 by using the activity data 11 (activity table 110). Also, the activity input module 12 inputs, in the activity data 11 (activity table 10) what is input into the activity-description input screen 120 by the operator's operation. In the activity-description input screen 120, items from a name item 1201 to a knowledge/information tab 1211 are displayed.

The name item 1201 is used to set a name of an activity.

An activity type item 1202 is used to select and input any of a manual operation, system processing and others, from a list.

A system name item 1203 is used to select and input a system corresponding to a system name of an activity, from a list.

A task classification item 1204 is used to select and input any of management, non-management and estimation, from a list.

An activity classification item 1205 is used to select and input from a list of predetermined activity classifications.

A responsible organization item 1206 is used to select and input an organization in charge of the activity from a list of predetermined organizations.

A person-in-charge item 1207 is used to input a person in charge (post, role, job or the like) of the activity.

A task description item 1206 is used to input a task description (activity description).

A separation-of-duties target activity item 1209 is checked when an activity serves as a duty separation unit in the separation-of-duties table. This item serves as activity related information.

By selecting an IT resource tab 1210, registration of resource information relating to an activity is prompted.

By selecting the knowledge/information tab 1211, registration of knowledge/information relating to an activity is prompted.

Contents of the resource attribute input screen 150 will be explained with reference to FIG. 7. The resource input module 15 displays the resource attribute input screen 150 by using the resource data 14 (IT resource table 140). The resource input module 15 inputs, in the resource data 14 (IT resource table 140), what is input into the resource attribute input screen 150 by the operator's operation. In the resource attribute input screen 150, items from a name item 1501 to a description item 1507 are displayed.

The name item 1501 is used to set a name of a resource.

An abbreviation item 1502 is used to input an abbreviation of the name of the resource.

A control department item 1503 is used to select and input a department which controls the resource, from a list of predetermined organizations.

A resource type item 1504 is used to select and input any of a master, system data, a screen and a system, from a list.

A system name item 1505 is used to input a system corresponding to an IT resource with reference to a predetermined list.

A resource classification item 1506 is used to select and input from a predetermined list regarding a resource classification.

A description item 1507 is used to input comments regarding the IT resource.

Contents of the knowledge/information attribute input screen 180 will be explained with reference to FIG. 8. The knowledge/information input module 18 displays the knowledge/information attribute input screen 180 by using the knowledge/information data 17 (knowledge information table 170). The knowledge/information input module 18 inputs, into the knowledge/information data 17 (knowledge information data table 170), what is input into the knowledge/information attribute input screen 180 by the operator's operation. In the knowledge/information attribute input screen 180, items from a name item 1801 to a description item 1810 are displayed.

The name item 1801 is used to input a name of knowledge/information.

A control department item 1802 is used to select and input a department which controls the knowledge/information, from the list of predetermined organizations.

A document item 1803 is used to select and input a document to be subjected to document management (managed by the repository 242).

A file name item 1804 is used to input a file name of a document selected in the document item 1803.

A data type item 1805 is used to select and input from a list of predetermined data types.

A document number item 1806 is used to input document number which is managed desirably.

A knowledge/information type item 1807 is used to select and input a type of knowledge/information from a predetermined list.

An auditing target flag item 1808 is checked when the knowledge/information constitutes an auditing target.

A knowledge/information classification item 1809 is used to select and input a classification of knowledge/information from a predetermined list.

The description item 1810 is used to input description regarding knowledge/information.

An example of a process for creating a document for an inner control will be described with reference to FIG. 9.

Steps S901 and S902 are processes executed by the business-process-narrative input module 32 or the activity input module 12.

At step S901, at first, a sub-step is input by an operator.

At step S902, a “activity” is roughly input in the business process narrative by the operator. For example, (i) attributes to be stored in the activity type column 113, the task classification column 115, the activity classification column 116 and the responsible organization column 117 and (ii) a task description to be stored in the task description column 119 are input.

Steps S903 and S904 are processes executed by the flowchart input module 42.

At step S903, an activity symbol is arranged in a flowchart in accordance with the operator's operation, and then the activity symbol and the activity are associated with each other in accordance with the operator's operation. The flowchart input module 42 presents to a user options for the activity symbol from an information-part sharing pool of the activity DB 238 or the like.

At step S904, a flowchart (mainly connection among the symbols) is drawn by the operator.

Up to here, the outline of the process flow is described by the operator.

At step S905, a process returns to the business process narrative by the operator's operation, and the activity is detailed. Chapter format and an activity are associated with each other. The business-process-narrative input module 32 supports standardization of hierarchic formation of the business process. That is, a name of a business process to be recommended and a granularity are displayed so as to be selectable. This is a process executed by the business-process-narrative input module 32 or the activity input module 12.

At step S906, resource and knowledge information relating to the activity input at step S905 are input. This is a process executed by the resource input module 15 or the knowledge/information input module 18.

At step S907, an activity symbol, a resource symbol and a knowledge/information symbol are added to the flowchart in accordance with the detailed business process narrative. At the same time, association between a symbol and an activity and a flow are also added. At that occasion, the flowchart input module 42 presents options for the activity. This is a process executed by the flowchart input module 42.

At step S908, step S905 through step S3908 are repeatedly executed, and a process flow description is sufficiently detailed.

At step S909, a risk and a control in RCM are input by the operator. This is a process executed by the RCM input module 52.

At step S910, a risk symbol and a control symbol are arranged in the flowchart. An activity and a risk are associated with each other. An activity and a control are associated with each other. At that occasion, the RCM input module 52 presents options for a risk and options for a control by using the risk/control/activity association module 53.

At step S911, a risk and a control in RCM are associated with each other by the operator. This is a process executed by the RCM input module 52 and the risk/control/activity association module 53.

Further, an order of the processes at step S909 and at step S910 may be reversed.

An access control of the basic four documents will be described below.

When the document for an inner control is created, an access authorization for the created document may be changed in accordance with a state of the created document. The state of the created document may be in any of (i) an editable state where the created document is editable, (ii) an acknowledged state where the created document is registered and (iii) an abandoned state where the created document is not dealt with. This process will be described in more detail below.

The created document has any of three states (editable/acknowledged/abandoned). For that purpose, it is managed which documenting process is executed currently for each document. Further, each documenting process is associated with any of the three states. When the documenting process is newly created, an editable state is set. The four documents can be created/edited/deleted/referenced in accordance with an authorization of the operator.

Only an operator having a specific authorization can change the documenting process from the editable state to the acknowledged state. Simultaneously with change of the state, the created four documents can be registered in the document processing server 230 having the repository 242.

When the created four documents are registered in the document processing server 230, a document attribute such as a document state may be set. Further, an operator who can reference a registered document may be designated by setting an access authorization.

When a document has already been registered in the document processing server 230, the document is registered with revision up (edition being changed to next edition) to register the document.

The created four documents may be registered in the document processing server 230 in units of the documenting process or in units of document regardless of a transition of states of the documenting process.

When the documenting process is brought into an acknowledged/abandoned state, all of the operators are prohibited from editing or deleting the documents.

Only an operator who has the certain specific authorization can change a state of the documenting process.

Further, according to the exemplary embodiment, a user is prompted to input necessary information so that elements such as a system, a resource, a risk and a control are classified and organized in terms of activities to form a database. Further, in inputting a relationship among the elements, the flowchart and RCM are provided as a user interface. Further, respective pieces of information such as the activities are shared to be available in another documenting process. By forming the information into parts, standardization of document levels and standardization of the business process can also be supported.

Further, the hierarchic levels expressing the business process of the business process narrative are broken down to the five levels. The level matching can be carried out by standardizing the break-down levels to the five levels.

The business process narrative can be automatically created from the business-process constituent element DB 10. Similarly, the list of the task step of the separation-of-duties table can automatically be created.

Further, the hardware configuration of a computer executing a program as the exemplary embodiment is a general computer as shown by FIG. 10, specifically, the client 220 is a personal computer or the like and the document processing server 230 is a computer which can be a server. The computer is constituted by CPU 901 for executing programs of modules of the activity input module 12, the resource input module 15, the knowledge/information input module 18, the sharing module 21 and the like, RAM 902 for storing the programs and data, ROM 903 stored with the program or the like for starting the computer, HD 904 as an auxiliary storing apparatus, an input apparatus 906 for inputting data of a keyboard, a mouse or the like, an output apparatus 905 of CRT or a liquid crystal display or the like, and a communication network interface 907 for connecting to a communication network, further, a bus 908 for exchanging data by connecting these. A plurality of pieces of the computers are connected by the network.

Further, the hardware configuration shown in FIG. 10 only shows one configuration example, the exemplary embodiment is not limited to the constitution shown in FIG. 10, and the hardware configuration may be a constitution capable of executing the modules explained in the exemplary embodiment. For example, a portion of the modules may be constituted by an exclusive hardware (for example, ASIC or the like). Further, particularly, other than the personal computer, the computer may be integrated to a portable telephone, a game machine, a car navigation machine, an intelligent household appliance, a copier, a facsimile, a scanner, a printer, a compound machine (also referred to as multifunction copier having functions of a scanner, a printer, a copier, a facsimile and the like).

Further, the explained program can also be stored in the record medium, further, the program can be provided also by communicating means. In this case, for example, the above-described program may also be regarded as an invention of “a computer readable record medium recorded with a program”.

“A computer readable record medium recoded with a program” means a computer readable record medium recorded with a program used for installing and executing a program, circulating a program.

Further, the record media include, for example, “DVD-R, DVD-RW, DVD-RAM or the like” constituting a digital versatile disk (DVD) and determined by a DVD forum, “DVD+R, DVD+RW or the like” constituting a standard and determined by DVD+RW, read only memory (CD-ROM), CD recordable (CD-R), CD rewritable (CD-RW) and the like constituting a compact disk (CD), a photomagnetic disk (MO), a flexible disk (FD), a magnetic tape, a hard disk, read only memory (ROM), electrically erasable and rewritable read only memory (EEPROM), flash memory, random access memory (RAM) and the like.

Further, a program or a portion thereof can be recorded to the record media to be preserved or circulated. Further, the program can be transmitted by using transmission media of a wired network, or a wireless communication network, further, a combination of these of a local area network (LAN), a metropolitan area network (MAN), a wide area network (WAN), an internet, an intranet, an extranet or the like and can be carried by being superposed on a carrier wave.

Further, the program may be a portion of other program, or may be recorded on a record media along with a separate program.

What is claimed is:

1. A document processing apparatus comprising:
an activity input unit that allows a user to input activities each including a name of the activity and a task description; and
a document creation unit that creates, based on the activities input through the activity input unit, a document for an inner control including at least one of a business process narrative describing a flow of each business process, a business flow diagram visually describing the flow of each business process, a risk control matrix indicating assumed risks and control activities corresponding to the respective risk and a separation-of-duties table showing a correspondence relation between a person in charge and each business process.

2. The document processing apparatus according to claim 1, wherein:
the activity input unit stores the name of each activity, the corresponding task description and an identifier of each activity in an activity storage unit in association with each other,
the document processing apparatus further comprising:
a resource input unit that allows the user to input a name of a resource corresponding to the identifier of each activity stored in the activity storage unit, wherein:
the resource input unit stores, in a resource storage unit, the input name of each resource and the identifier of the activity corresponding to the input name of each resource in association with each other.

3. The document processing apparatus according to claim 1, wherein:
the activity input unit stores the name of each activity, the corresponding task description and an identifier of each activity in an activity storage unit in association with each other,
the document processing apparatus further comprising:
a knowledge input unit that allows the user to input a name of knowledge corresponding to the identifier of each activity stored in the activity storage unit, wherein:
the knowledge input unit stores, in a knowledge storage unit, the input name of each knowledge and the identifier of the activity corresponding to the input name of each knowledge in association with each other.

4. The document processing apparatus according to claim 1, wherein:
the activity input unit stores the name of each activity, the corresponding task description and an identifier of each activity in an activity storage unit in association with each other,
the document processing apparatus further comprising:
a business-process-narrative input unit that allows the user to input (i) levels of plural classes, which represent the business process, and (ii) the identifiers of the plural activities, wherein:
the business-process-narrative input unit stores, in a business-process-narrative storage unit, the input level of each class and the identifier of the activity corresponding to the level of each class in association with each other.

5. The document processing apparatus according to claim 4, further comprising:
a separation-of-duties input unit that allows the user to input persons in charge of the levels of the classes which represent the business process and which are stored in the business-process-narrative storage unit, wherein:
the separation-of-duties input unit stores, in a separation-of-duties storage unit, the input persons in charge and the levels of the corresponding classes in association with each other.

6. The document processing apparatus according to claim 1, wherein:
the activity input unit stores the name of each activity, the corresponding task description and an identifier of each activity in an activity storage unit in association with each other,
the document processing apparatus further comprising:
a flow input unit that allows the user to input (i) a name of a symbol corresponding to the identifier of each activity stored in the activity storage unit and (ii) information regarding a position of the symbol, wherein:
the flow input unit stores, in a flow storage unit, the input name of each symbol, the information regarding the position of each symbol and the corresponding identifier of the activity in association with each other.

7. The document processing apparatus according to claim 1, wherein:
the activity input unit stores the name of each activity, the corresponding task description and an identifier of each activity in an activity storage unit in association with each other,
the document processing apparatus further comprising:
a risk input unit that inputs an identifier of a risk corresponding to the identifier of each activity stored in the activity storage unit, the risk input unit that stores the input identifier of each risk and the identifier of the corresponding activity in a risk storage unit in association with each other;
a control input unit that inputs an identifier of a control corresponding to the identifier of each activity stored in the activity storage unit, the control input unit that stores the input identifier of each control and the identifier of the corresponding activity in a control storage unit in association with each other; and
a risk/control input unit that stores each risk identifier and the corresponding control in a risk/control storage unit in association with each other.

8. The document processing apparatus according to claim 1, wherein:
when the document creation unit creates the document for the inner control, the document creation unit changes an access authorization for the created document in accordance with a state of the created document, and
the state of the created document is in any of (i) an editable state where the created document is editable, (ii) an acknowledged state where the created document is registered and (iii) an abandoned state where the created document is not dealt with.

9. The document processing apparatus according to claim 7, wherein:
the activity input unit stores the name of each activity, the corresponding task description and an identifier of each activity in an activity storage unit in association with each other,
the document processing apparatus further comprising:
a resource input unit that allows the user to input a name of a resource corresponding to the identifier of each activity stored in the activity storage unit, wherein the resource input unit stores, in a resource storage unit, the input name of each resource and the identifier of the activity corresponding to the input name of each resource in association with each other;
a knowledge input unit that allows the user to input a name of knowledge corresponding to the identifier of each activity stored in the activity storage unit, wherein the knowledge input unit stores, in a knowledge storage unit, the input name of each knowledge and the identifier of the activity corresponding to the input name of each knowledge in association with each other;
a business-process-narrative input unit that allows the user to input (i) levels of plural classes, which represent the business process, and (ii) the identifiers of the plural activities, wherein the business-process-narrative input unit stores, in a business-process-narrative storage unit, the input level of each class and the identifier of the activity corresponding to each class in association with each other;
a separation-of-duties input unit that allows the user to input persons in charge of the levels of the classes which represent the business process and which are stored in the business-process-narrative storage unit, wherein the separation-of-duties input unit stores, in a separation-of-duties storage unit, the input persons in charge and the levels of the corresponding classes in association with each other; and
a flow input unit that allows the user to input (i) a name of a symbol corresponding to the identifier of each activity stored in the activity storage unit and (ii) information regarding a position of the symbol, wherein the flow input unit stores, in a flow storage unit, the input name of each symbol, the information regarding the position of each symbol and the corresponding identifier of the activity in association with each other.

10. A computer readable medium storing a program causing a computer to execute document processing, the document processing comprising:
allowing a user to input activities each including a name of the activity and a task description; and
creating, based on the activities input, a document for an inner control including at least one of a business process narrative describing a flow of each business process, a business flow diagram visually describing the flow of each business process, a risk control matrix indicating assumed risks and control activities corresponding to the respective risk and a separation-of-duties table showing a correspondence relation between a person in charge and each business process.

11. The medium according to claim 10, wherein the document processing further comprises:
storing the name of each activity, the corresponding task description and an identifier of each activity in an activity storage unit in association with each other;
allowing the user to input a name of a resource corresponding to the identifier of each activity stored in the activity storage unit; and
storing, in a resource storage unit, the input name of each resource and the identifier of the activity corresponding to the input name of each resource in association with each other.

12. The medium according to claim 10, wherein the document processing further comprises
storing the name of each activity, the corresponding task description and an identifier of each activity in an activity storage unit in association with each other;
allowing the user to input a name of knowledge corresponding to the identifier of each activity stored in the activity storage unit; and
storing, in a knowledge storage unit, the input name of each knowledge and the identifier of the activity corresponding to the input name of each knowledge in association with each other.

13. The medium according to claim 10, wherein the document processing further comprises:
storing the name of each activity, the corresponding task description and an identifier of each activity in an activity storage unit in association with each other;
allowing the user to input (i) levels of plural classes, which represent the business process, and (ii) the identifiers of the plural activities; and
storing, in a business-process-narrative storage unit, the input level of each class and the identifier of the activity corresponding to the level of each input class in association with each other.

14. The medium according to claim 13, wherein the document processing further comprises:
allowing the user to input persons in charge of the levels of the classes which represent the business process and which are stored in the business-process-narrative storage unit; and
storing, in a separation-of-duties storage unit, the input persons in charge and the levels of the corresponding classes in association with each other.

15. The medium according to claim 10, wherein the document processing further comprises:
storing the name of each activity, the corresponding task description and an identifier of each activity in an activity storage unit in association with each other;
allowing the user to input (i) a name of a symbol corresponding to the identifier of each activity stored in the activity storage unit and (ii) information regarding a position of the symbol; and
storing, in a flow storage unit, the input name of each symbol, the information regarding the position of each symbol and the corresponding identifier of the activity in association with each other.

16. The medium according to claim 10, wherein the document processing further comprises:
storing the name of each activity, the corresponding task description and an identifier of each activity in an activity storage unit in association with each other;
inputting an identifier of a risk corresponding to the identifier of each activity stored in the activity storage unit;
storing the input identifier of each risk and the identifier of the corresponding activity in a risk storage unit in association with each other;
inputting an identifier of a control corresponding to the identifier of each activity stored in the activity storage unit;
storing the input identifier of each control and the identifier of the corresponding activity in a control storage unit in association with each other; and
storing each risk identifier and the corresponding control in a risk/control storage unit in association with each other.

17. The medium according to claim 10, wherein the document processing further comprises:
changing an access authorization for the created document in accordance with a state of the created document, wherein:
the state of the created document is in any of (i) an editable state where the created document is editable, (ii) an acknowledged state where the created document is registered and (iii) an abandoned state where the created document is not dealt with.

18. The medium according to claim 16, wherein the document processing further comprises:
storing the name of each activity, the corresponding task description and an identifier of each activity in an activity storage unit in association with each other;
allowing the user to input a name of a resource corresponding to the identifier of each activity stored in the activity storage unit;
storing, in a resource storage unit, the input name of each resource and the identifier of the activity corresponding to the input name of each resource in association with each other;
allowing the user to input a name of knowledge corresponding to the identifier of each activity stored in the activity storage unit;
storing, in a knowledge storage unit, the input name of each knowledge and the identifier of the activity corresponding to the input name of each knowledge in association with each other;
allowing the user to input (i) levels of plural classes, which represent the business process, and (ii) the identifiers of the plural activities;
storing, in a business-process-narrative storage unit, the input level of each class and the identifier of the activity corresponding to each class in association with each other;
allowing the user to input persons in charge of the levels of the classes which represent the business process and which are stored in the business-process-narrative storage unit;
storing, in a separation-of-duties storage unit, the input persons in charge and the levels of the corresponding classes in association with each other;
inputting (i) a name of a symbol corresponding to the identifier of each activity stored in the activity storage unit and (ii) information regarding a position of the symbol; and
storing, in a flow storage unit, the input name of each symbol, the information regarding the position of each symbol and the corresponding identifier of the activity in association with each other.
